(19) United States
(12) Patent Application Publication
(10) Pub. No.: US 2005/0166063 A1
(43) Pub. Date: Jul. 28, 2005

(54) Wireless multi-functional computer lock

(76) Inventor: Zyh-Ming Huang, Taipei Hsien (TW)

Correspondence Address: ZYH-MING HUANG, 235 Chung-Ho, P.O. BOX 10-69, Taipei, TW

(21) Appl. No.: 10/764,756

(22) Filed: Jan. 27, 2004

(51) Int. Cl. H04K 1/00

(52) U.S. Cl. 713/186

(57) ABSTRACT

A wireless multi-functional computer lock comprises at least one meter for measuring at least one of blood pressures, pulses, body temperatures and times of moving steps of a person; a wireless transmitter for transmitting measuring data from the air inlet one meter; a receiver installed on a computer and communicated to the wireless transmitter wirelessly for receiving the data from the wireless transmitter. The wireless transmitter is used to actuate the receiver on the computer so as to enter into a process of inputting passwords, browsing the data and lock the data display on the computer. The wireless transmitter comprises a time switch and a processor, and the time switch serves to select a time period to set the actuate time of the computer.

### FIELD OF THE INVENTION

The present invention relates to computer security, and particular to a wireless multi-functional computer lock which can be used to transfer measuring data of human body to a computer and display the data. Moreover, the user can lock and unlock the display of the data through a receiver.

### BACKGROUND OF THE INVENTION

In the prior art DOS environment, no security function is provided to users when the user leaves from an operating computer. In the window environment, it provides a screen protection program used in a single one computer. However, the security mechanism has a simple structure and is protected by a simple structured code which can be decoded easily. Most of users uses the familiar software, but they can not skill the security program in the complicated window environment, as shown in FIG. 1. In the prior art computer, if the computer has no security system, it is very possible that important data is stolen. Furthermore, if the security function is not perfect, the stealer can get the pass words by reversely assembling ASCII codes.

A receiver uses a USB interface to communicate with a computer. When the user installs a dedicated security software of a wireless identifying lock in a window environment, a drive can be installed in the window environment so that the receiver 1 can communicate with the security program through the USB interface and control the actuation and de-actuation of the security software, as shown in FIGS. 2 and 3. When the receiver 1 and transmitter 2 are used at the same time, the communication of the receiver 1 and the transmitter 2 is performed through the same frequencies by transferring acknowledge set by users. If the distance between the transmitter 2 and the receiver 1 is over a predetermined distance, the receiver 1 can not receive the signals from the transmitter 2. The receiver 1 will actuate a security software through a USB interface. At this moment, the operation of the computer will switch into a lock mode from a window mode so as to protect the data within the computer. When the user returns to the computer, the receiver 1 will receive signals from the transmitter 2. The security software can be released by the receiver 1 through the USB interface. Then, the lock frame is switched into the window frame. Thereby, when the user can users the computer directly.

When the lock frame controlled by the security software presents an alarm message, it will inform a stealer that it is an illegal invader.

In the security software, the passwords may contain at least one of the addresses, ages, secret codes, telephone numbers, names of wives, etc., the user must input at least one of these data for actuating the window. Not all the fields are set with security codes, but for those are set with security codes, the stealer must input the code for stealing the data. The possibility to correctly decode the security code is very few, at a level of 10⁻¹². Thereby, the steal cannot decode the security code at the time period that the user leaves the computer. Thus the object of protecting the data of the user is achieved.

However, above mentioned prior art has the following defects. The time period of using a computer cannot be limited. The use of the prior art can show the measuring data of users, such as pulses, blood pressures or step numbers, etc. The data may be stolen easily.

### SUMMARY OF THE INVENTION

Accordingly, the primary object of the present invention is to provide a wireless multi-functional computer lock, which can be used to transfer measuring data of human body to a computer and display the data. Thereby, the user can lock and unlock the display of the data through a receiver.

To achieve above object, the present invention provides a wireless multi-functional computer lock. The wireless multi-functional computer lock comprises at least one meter for measuring at least one of a blood pressure, pulse, body temperature and times of steps; a wireless transmitter for transmitting measuring data from the air inlet one meter; a receiver installed on a computer and communicated to the wireless transmitter wirelessly for receiving the data from the wireless transmitter, The wireless transmitter is used to actuate the receiver on the computer so as to enter into an process of inputting passwords, browsing the data and locking the data display on the computer display. The wireless transmitter comprises a time switch and a processor, and the time switch serves to select a time period to set the actuate time of the computer.

The various objects and advantages of the present invention will be more readily understood from the following detailed description when read in conjunction with the appended drawing.

### BRIEF DESCRIPTION OF THE DRAWINGS

FIG. 1 is a schematic view showing the use of the prior art.

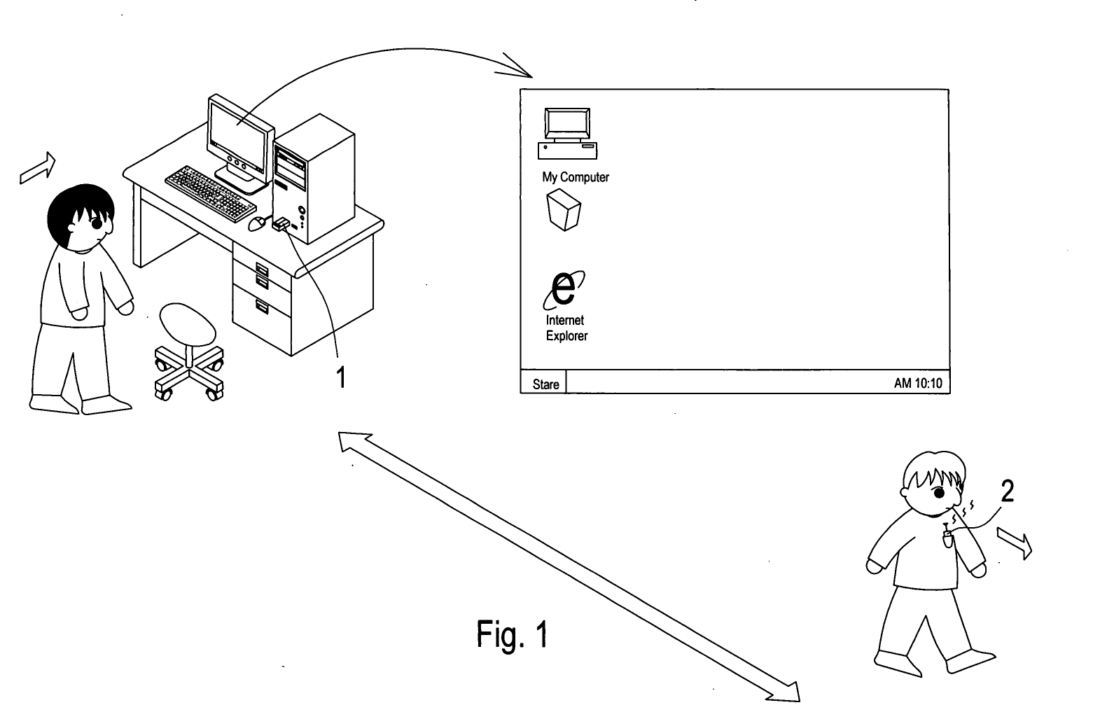

FIG. 2 is a schematic view showing an operation of the present invention, where the user is went out.

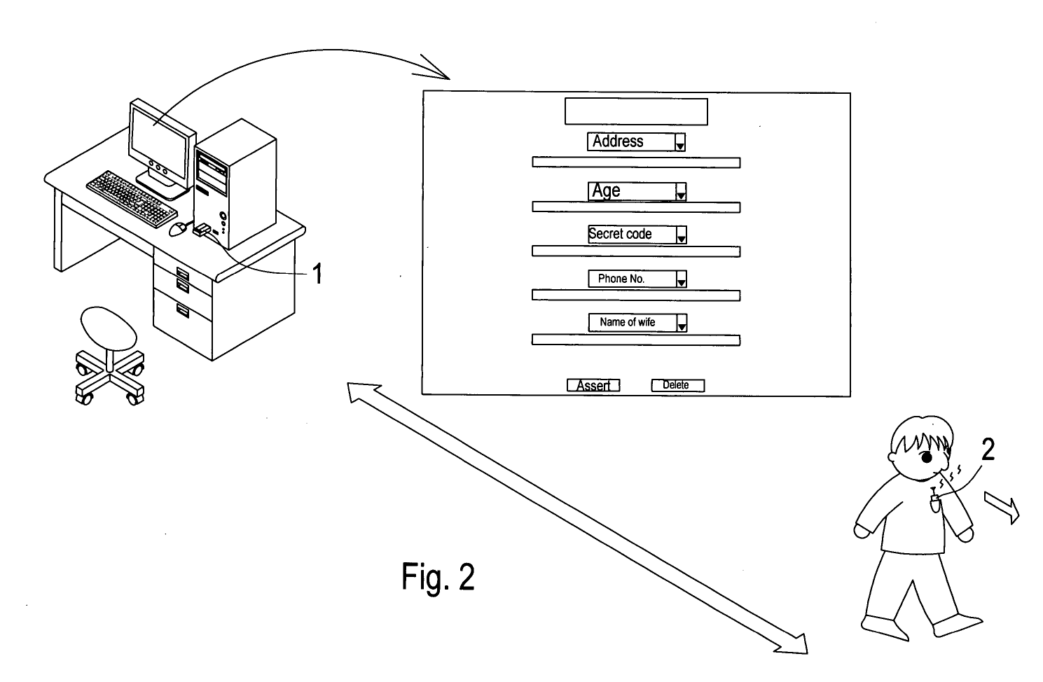

FIG. 3 is a schematic view showing an operation of the present invention, where the user returns.

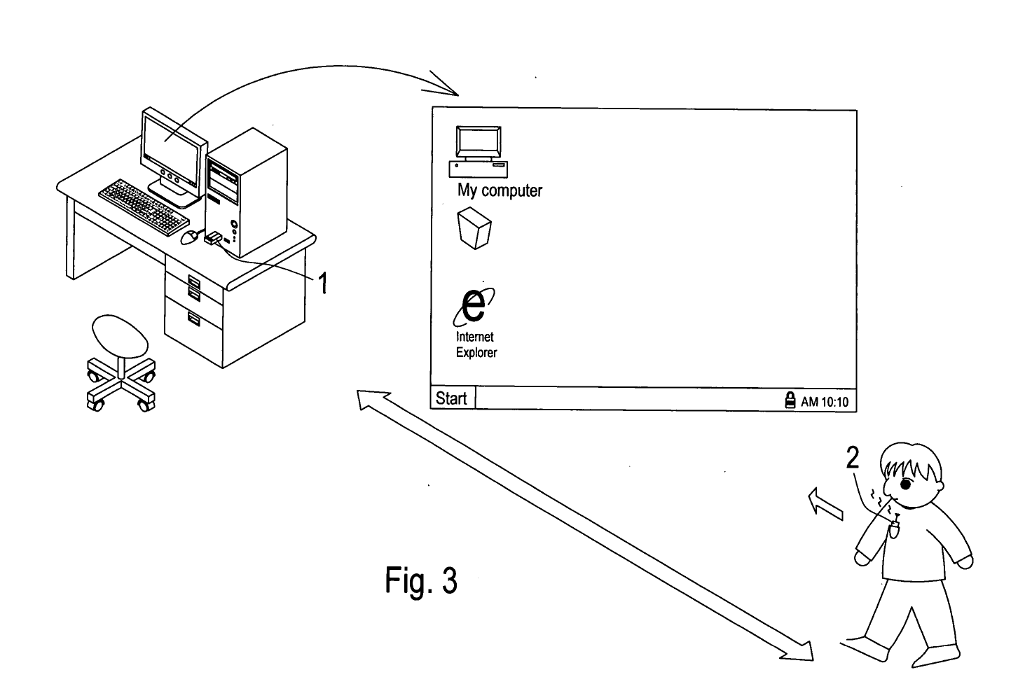

FIG. 4 shows the measurement operation of the present invention.

FIG. 5 shows the control of the wireless transmitter and receiver of the present invention.

FIG. 6 shows one embodiment of selection of the timer control field of the present invention.

FIG. 7 shows another embodiment of selection of the timer control field of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

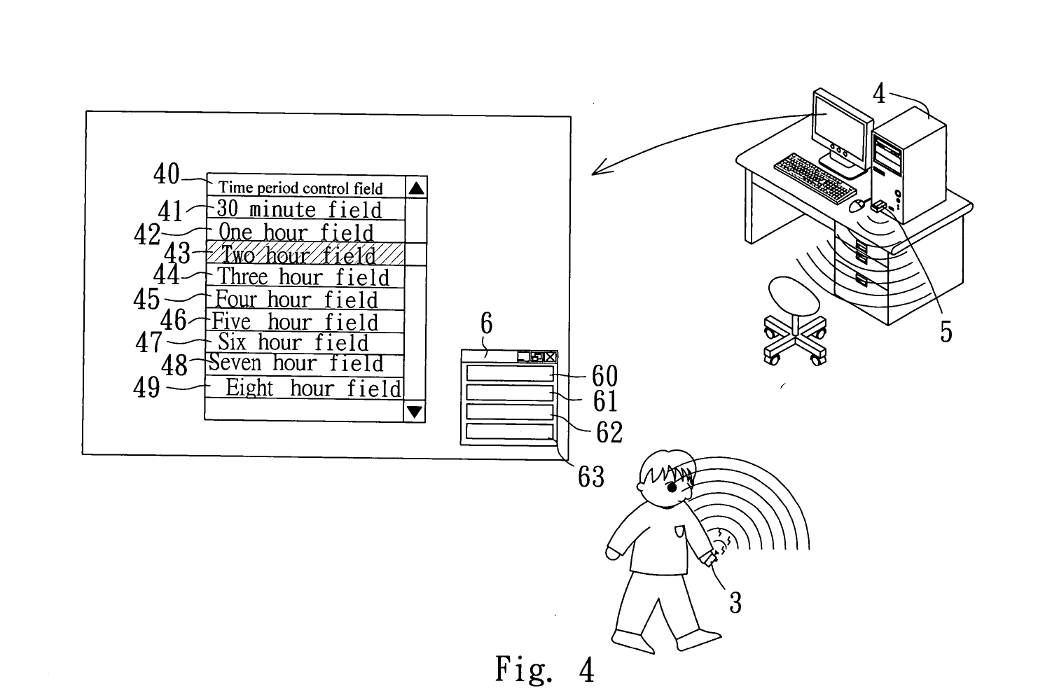

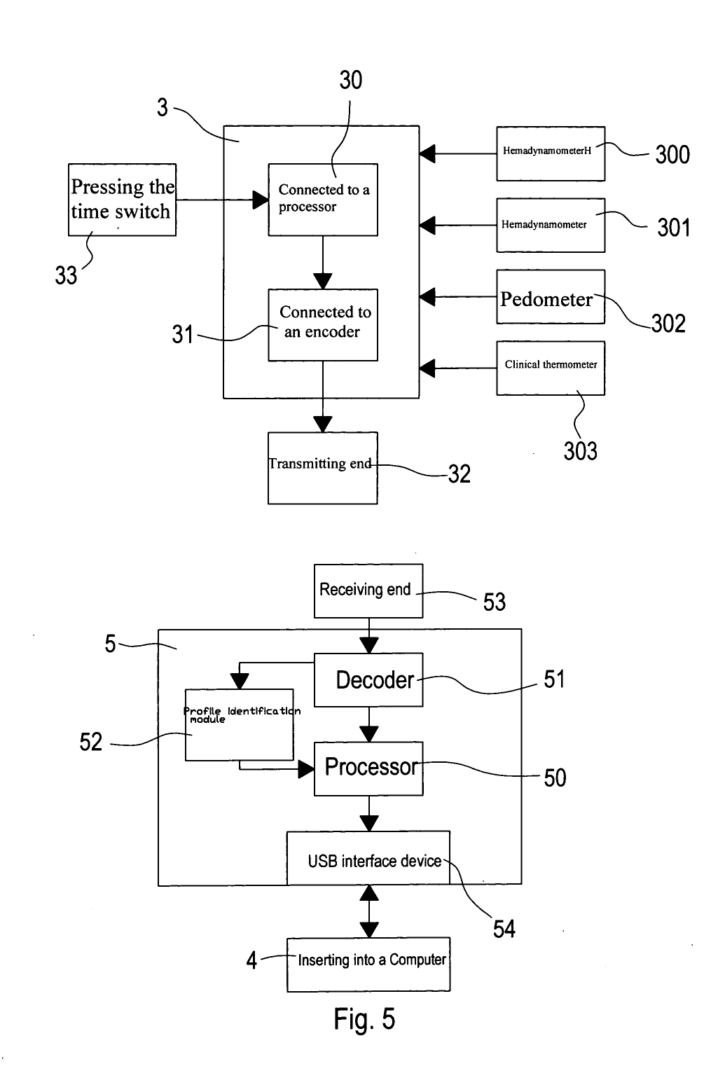

With reference to FIGS. 4 and 5, a wireless multi-functional computer lock of the present invention is illustrated. The wireless multi-functional computer lock has a protocol wireless transmitter 3. The wireless transmitter 3 is wirelessly transmitted to the receiver 5 installed on a computer 4 confidentially. A safety mechanism is provided by the wireless transmitter 3 and the computer 4. A processor 30 is installed in the wireless transmitter 3 and is connected to an encoder 31. The wireless transmitter 3 is connected to a hemadynamometer 300, a pulsimeter 301, a pedometer 302 and a clinical thermometer 303 through the processor 30. The detected data is transferred out from a transmitting end 32 of the transmitter 3. The wireless transmitter 3 is installed with a time switch 33 to be connected to a processor 30. By pressing the time switch 33 to select a time period to be confined to control the use of the computer 4. Moreover, the transmitting end 32 serves to actuate the receiver 5 on the computer 4. The receiver 5 has a processor 50 and a decoder 51 which are electrically connected and the receiver 5 is further connected to a profile identifying module 52. The decoder 51 is connected to a receiving end 53. The decoder 51 is used to decode data. By a profile identification forming a safety mechanism, after the wireless transmitter 3 transmits a signal to assure the correction of the signal, the wireless transmitter 3 is connected to the computer 4 through the processor 30 and an USB interface device 54.

The present invention further comprises a safety mechanism. When the user moves near the computer 4, a security software is actuated and a data window 6 is opened. The data window 6 includes a blood pressure display window 60, a pulse display window 62, a pedometer display window 62 and a clinical thermometer display window 63 for displaying the pulses, blood pressure, etc. of human body. The wireless transmitter 3 can be hung on the neck or before the breast for sensing the desired data. The measured data is transferred to the computer 4 through the receiver 5. These data are displayed by the blood pressure display window 60, pulse display window 62, pedometer display window 62 and clinical thermometer display window 63. The user can move the cursor on the computer 4 to a left upper corner of the data window 6 to close the data window 6.

In the wireless multi-functional computer lock, a timer control field 40 can be added to the computer 4 based on the distance between the wireless transmitter 3 and the receiver 5 for confining the time period of the computer 4. The time period control field 40 includes, for example, a 30 minute field 41, a one hour field 42, a two hour field 43, a three hour field 44, a four field 45, a five hour field 46, a six hour field 47, a seven hour field 48, an eight hour field 49, for confining the time period of the computer 4.

The application of the present invention will be described here. In the present invention, the hemadynamometer 300, pulsimeter 301, pedometer 302 and clinical thermometer 303 are used to measure related data. Then the data is transferred to the receiver 5 of the computer 4 by the wireless transmitter 3 so that the data can be displayed on the computer 4 in any time. Meanwhile, a time control field 40 is added to the computer 4 for confining the user of the computer 4.

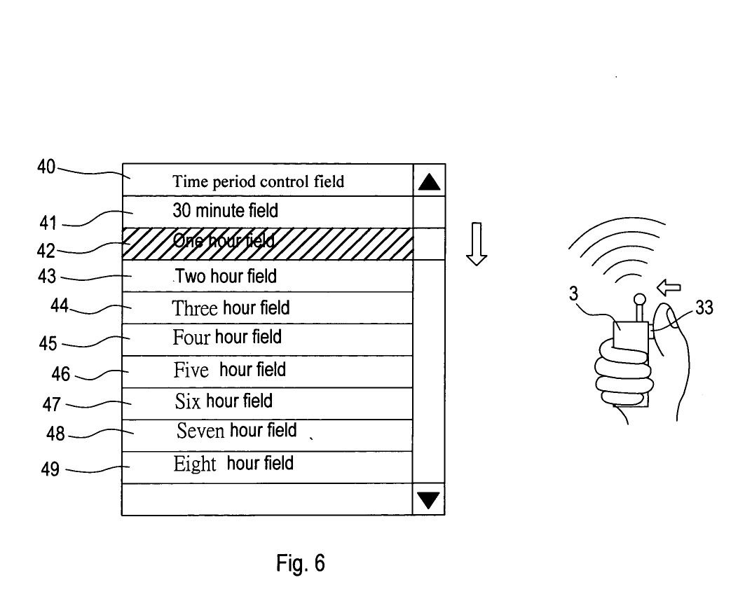

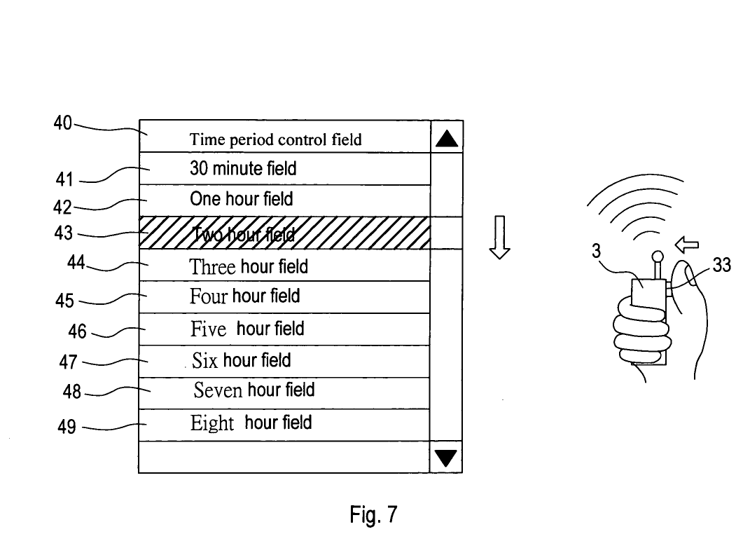

With reference to FIGS. 6 and 7, it is illustrated that the computer 4 includes a timer control field 40. A time switch 33 is added to the wireless transmitter 3 to be connected to the processor 30. The time period on the timer control field 40 is selected by pressing the time switch 33. The timer control field 40 has a plurality of field for being used to confine the use of the computer 4. The time period control field 40 includes, the 30 minute field 41, one hour field 42, two hour field 43, three hour field 44, four field 45, five hour field 46, six hour field 47, seven hour field 48, eight hour field 49, for confining the time period of the computer 4.

When the user presses the time switch 33 and then the user can enter into the timer control field 40 to select one of the 30 minute field 41, one hour field 42, two hour field 43, three hour field 44, four field 45, five hour field 46, six hour field 47, seven hour field 48, eight hour field 49. The computer 4 will close after a period selected from one of the plurality of fields.

In the present invention, the operation of the security program is not affected by the use of the wireless transmitter 3 and receiver 5. When the user desires to leave the work for a while, the user clicks a lock icon at the right lower corner of the window. Then the security program will be actuated. The computer 4 will retain the frame. After the user returns, the user may release the lock of the frame. Then the frame of the computer 4 returns to the window from locking state. The user can use the computer 4 normally. In the process, the security data can be protected.

Advantages of the present invention will be described herein. The time period in actuating the computer is confined. The hemadynamometer, pulsimeter, pedometer and clinical thermometer are connected to the computer so that the user can check the measured data conveniently. The computer can be locked automatically. The lock can be released automatically. Moreover, it is difficult to decode and steal the data. The present invention provide a multi protection service to users so that it is very time-consumed and difficult to decode the data of the present invention.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A wireless multi-functional computer lock comprising:
at least one meter for measuring at least one of blood pressures, pulses, body temperatures and times of moving steps of a person;
a wireless transmitter for transmitting measuring data from the at least one meter;
a receiver installed on a computer and communicated to the wireless transmitter wirelessly for receiving the data from the wireless transmitter;
wherein the wireless transmitter is used to actuate and lock the receiver on the computer so as to enter into an process of inputting passwords, browsing the data and locking the display of the data on the display window of the computer.

2. The wireless multi-functional computer lock as claimed in claim 1, wherein the wireless transmitter comprises a time switch and a processor, and the time switch serves to select a time period to set the actuate time of the computer.

3. The wireless multi-functional computer lock as claimed in claim 1, wherein the time period is selected from one of a 30 minute field, a one hour field, a two hour field, a three hour field, a four field, a five hour field, a six hour field, a seven hour field, and an eight hour field which sets a corresponding time period for actuation the computer.

4. The wireless multi-functional computer lock as claimed in claim 1, wherein the processor of the wireless transmitter is connected to a hemadynamometer for measuring blood pressures of a user; measuring data are then transferred from a transmitting end of the wireless transmitter to be displayed on a blood pressure display window in the computer.

5. The wireless multi-functional computer lock as claimed in claim 1, wherein the processor of the wireless transmitter is connected to a pulsimeter for measuring pulses; measuring data are then transferred from a transmitting end of the wireless transmitter to be displayed on a pulse display window in the computer.

6. The wireless multi-functional computer lock as claimed in claim 1, wherein the processor of the wireless transmitter is connected to a pedometer for measuring moving steps of users; measuring data are then transferred from a transmitting end of the wireless transmitter to be displayed on a blood pressure display window in the computer.

7. The wireless multi-functional computer lock as claimed in claim 1, wherein the processor of the wireless transmitter is connected to a clinical thermometer for measuring body temperatures of the user; measuring data are then transferred from a transmitting end of the wireless transmitter to be displayed on a blood pressure display window in the computer.
